(19) United States
(12) Patent Application Publication
(10) Pub. No.: US 2007/0165038 A1
(43) Pub. Date: Jul. 19, 2007

(54) Information processing apparatus and operation control method for use in the same

(75) Inventors: Hiroaki Chiba, Sagamihara-shi (JP); Shigeru Kizaki, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/656,507

(22) Filed: Jan. 23, 2007

(30) Foreign Application Priority Data
Jan. 13, 2006 (JP) 2006-013722

(51) Int. Cl. G06F 13/14

(52) U.S. Cl. 345/520

(57) ABSTRACT

According to one embodiment, an information processing apparatus includes an external display connection terminal, a display controller which receives video data from software and generates a digital video signal from the received video data, an interface control circuit which outputs the digital video signal, which is generated by the display controller, to an outside via the external display connection terminal, and a control unit which sets the interface control circuit in an operative state after an operating system, which has a content protection function for protecting the video data against unlawful use, is booted up.

### CROSS-REFERENCE TO RELATED APPLICATIONS

This application is based upon and claims the benefit of priority from Japanese Patent Application No. 2006-013722, filed Jan. 23, 2006, the entire contents of which are incorporated herein by reference.

### BACKGROUND

1. Field

One embodiment of the invention relates to an information processing apparatus such as a personal computer, and more particularly to an information processing apparatus that is capable of outputting a digital video signal to the outside, and an operation control method for use in the apparatus.

2. Description of the Related Art

In recent years, personal computers having the same AV functions as in audio-video apparatuses such as DVD (Digital Versatile Disc) players and TV apparatuses have been developed. Most of personal computers of this kind have functions of receiving broadcast program data.

Jpn. Pat. Appln. KOKAI Publication No. 2005-78356 discloses a home server having a built-in TV tuner. The home server includes not only a CPU, but also a stream processor which processes stream data such as broadcast content.

In order to activate the CPU after the stream processor is activated, the home server has a function of de-asserting a reset signal that is supplied to the CPU after a reset signal that is supplied to the stream processor is de-asserted.

In the meantime, with recent development in digitalization of broadcast, there has been a demand, even in the field of personal computers, for mounting a digital output interface which can output a digital video signal to an external display device such as a TV.

The mounting of the digital output interface enables the computer to output high-image-quality video data to the outside.

Thus, in the computer having the digital output interface, it is necessary to enhance a copyright protection function in order to prevent unlawful copy of high-image-quality video contents such as broadcast programs.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing the external appearance of an information processing apparatus according to an embodiment of the invention;

FIG. 2 is an exemplary block diagram showing an example of the system configuration of the information processing apparatus according to the embodiment;

FIG. 3 is an exemplary block diagram showing the structure of a display controller (GPU) and its peripheral circuits, which are provided in the information processing apparatus according to the embodiment;

FIG. 4 is an exemplary flow chart for explaining a reset release sequence which is executed by the information processing apparatus according to the embodiment;

FIG. 5 is an exemplary flow chart for explaining another example of the reset release sequence which is executed by the information processing apparatus according to the embodiment;

FIG. 6 is an exemplary flow chart for explaining a procedure which is executed by an EC/KBC provided in the information processing apparatus according to the embodiment;

FIG. 7 is an exemplary flow chart for explaining a procedure which is executed by a system BIOS that is used in the information processing apparatus according to the embodiment;

FIG. 8 is an exemplary flow chart for explaining a procedure which is executed by a display driver that is used in the information processing apparatus according to the embodiment; and

FIG. 9 is an exemplary block diagram showing another example of the structure of the display controller (GPU) and its peripheral circuits, which are provided in the information processing apparatus according to the embodiment.

### DETAILED DESCRIPTION

Various embodiments according to the invention will be described hereinafter with reference to the accompanying drawings. In general, according to one embodiment of the invention, an information processing apparatus includes: an external display connection terminal; a display controller which receives video data from software and generates a digital video signal from the received video data; an interface control circuit which outputs the digital video signal, which is generated by the display controller, to an outside via the external display connection terminal; and a control unit which sets the interface control circuit in an operative state after an operating system, which has a content protection function for protecting the video data against unlawful use, is booted up.

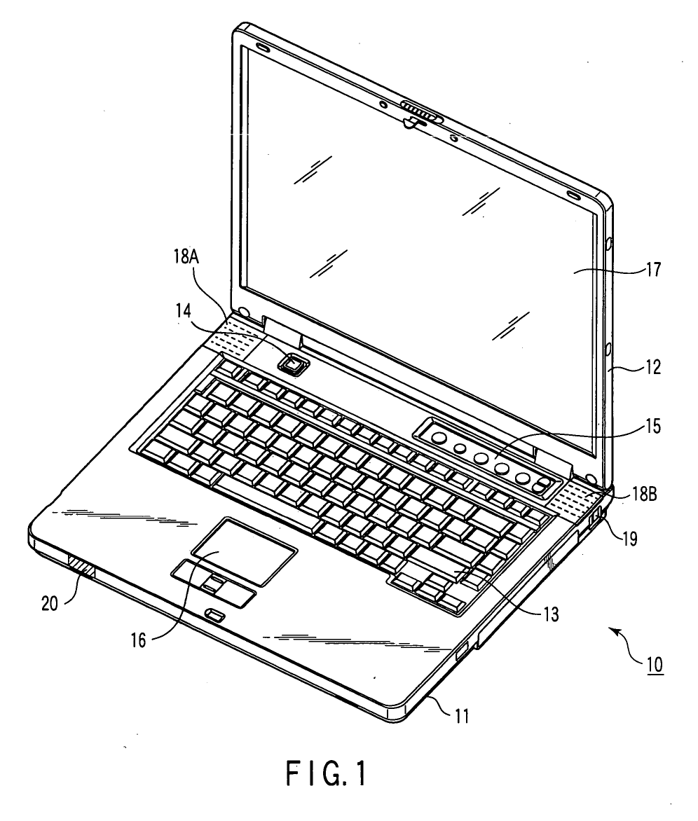

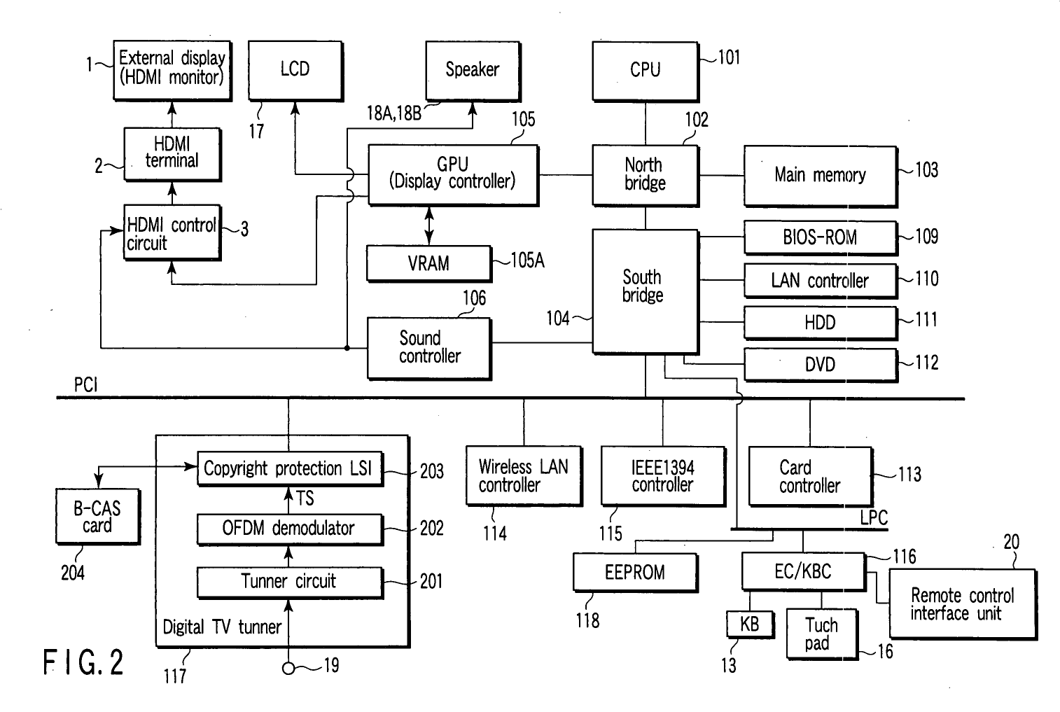

To begin with, referring to FIG. 1 and FIG. 2, the structure of an information processing apparatus according to an embodiment of the invention is described. The information processing apparatus is realized, for example, as a notebook portable personal computer 10.

FIG. 1 is a perspective view that shows the state in which a display unit of the notebook personal computer 10 is opened. The computer 10 comprises a computer main body 11 and a display unit 12. A display device that is composed of a TFT-LCD (Thin Film Transistor Liquid Crystal Display) 17 is built in the display unit 12. The display screen of the LCD 17 is positioned at an approximately central part of the display unit 12.

The display unit 12 is attached to the computer main body 11 such that the display unit 12 is freely rotatable between an open position and a closed position. The computer main body 11 has a thin box-shaped casing. A keyboard 13, a power button 14 for powering on/off the computer 10, an input operation panel 15, a touch pad 16 and speakers 18A, 18B are disposed on the top surface of the computer main body 11.

The input operation panel 15 is an input device that inputs an event corresponding to a pressed button. The input operation panel 15 has a plurality of buttons for activating a plurality of functions. The buttons include an operation button for controlling a TV function of the computer 10.

A remote-control unit interface unit 20, which executes communication with a remote-control unit that controls the TV function of the computer 10, is provided on a front surface of the computer main body 11. The remote-control interface unit 20 is composed of, e.g. an infrared signal receiving unit.

The computer 10 is capable of receiving and reproducing digital broadcast program data such as ground-wave digital TV broadcast program data. An antenna terminal 19 for ground-wave digital TV broadcast is provided, for example, on a right side surface of the computer main body 11. In addition, on a rear surface of the computer main body 11, there is provided an external display connection terminal corresponding to, e.g. HDMI (high-definition multimedia interface) standard. The external display connection terminal is used to output a digital video signal, which corresponds to digital broadcast program data such as ground-wave digital TV broadcast program data, to an external display device such as a TV receiver.

Referring now to FIG. 2, the system configuration of the computer 10 is described.

As shown in FIG. 2, the computer 10 includes a CPU 101, a north bridge 102, a main memory 103, a south bridge 104, a graphics processing unit (GPU) 105, a video memory (VRAM) 105A, a sound controller 106, a BIOS-ROM 109, a LAN controller 110, a hard disk drive (HDD) 111, a DVD drive 112, a card controller 113, a wireless LAN controller 114, an IEEE 1394 controller 115, an embedded controller/keyboard controller IC (EC/KBC) 116, a digital TV tuner 117, and an EEPROM 118.

Of these components, the CPU 101, north bridge 102, main memory 103, south bridge 104, graphics processing unit (GPU) 105, video memory (VRAM) 105A, sound controller 106, BIOS-ROM 109, LAN controller 110, card controller 113, wireless LAN controller 114, IEEE 1394 controller 115, embedded controller/keyboard controller IC (EC/KBC) 116 and EEPROM 118 are provided on a system board which is provided in the computer main body 11, and the components on the system board function as a system unit.

The digital TV tuner 117 is realized as a unit independent from the system board. For example, the TV tuner 117 is mounted on a tuner board which is different from the system board. The TV tuner 117 has an encrypting function, and encrypts received broadcast program data and outputs the encrypted broadcast program data to the system unit. The encryption of the broadcast program data is executed on the basis of an encryption key which is stored in the TV tuner 117.

The system unit executes a process of storing the encrypted broadcast program data, which is output from the digital TV tuner 117, into a storage device, e.g. HDD 111, a process of decrypting the encrypted broadcast program data, which is stored in the HDD 111, on the basis of the encryption key that is stored in the digital TV tuner 117, and a process of reproducing the decrypted broadcast program data.

Next, the functions of the respective components are described.

The CPU 101 is a processor which controls the operation of the computer 10. The CPU 101 executes an operating system and various application programs, which are loaded from the hard disk drive (HDD) 111 into the main memory 103. The CPU 101 also executes a system BIOS (Basic Input/Output System) that is stored in the BIOS-ROM 109. The system BIOS is a program for hardware control. The BIOS-ROM 109 also stores a video BIOS (VGA BIOS) for controlling the GPU 105.

The north bridge 102 is a bridge device that connects a local bus of the CPU 101 and the south bridge 104. The north bridge 102 includes a memory controller that access-controls the main memory 103. The north bridge 102 has a function of executing communication with the GPU 105 via, e.g. a PCI EXPRESS serial bus.

The GPU 105 is a display controller for controlling the LCD 17 that is used as an internal display device of the computer 10. A video signal, which is generated by the GPU 105, is sent to the LCD 17. In addition, the GPU 105 can send a digital video signal to an external display device 1 via an HDMI control circuit 3 and an HDMI terminal 2.

The HDMI terminal 2 is the above-mentioned external display connection terminal. The HDMI terminal 2 can send both a digital video signal and a digital audio signal via a single cable to the external display device 1 such as a TV receiver.

The HDMI control circuit 3 is an interface control circuit for sending the digital video signal, which is generated by the GPU 105, to the external display device 1 which is called “HDMI monitor” via the HDMI terminal 2.

The HDMI control circuit 3 has a content protection function such as HDCP (High-bandwidth Digital Content Protection System). The HDMI control circuit 3 executes a verification process for determining whether the external display device 1, which is connected to the HDMI terminal 2, is a lawful device which supports a content protection function such as HDCP. The HDMI control circuit 3 outputs a digital video signal only when the external display device 1 is determined to be a lawful device. Thereby, the digital video signal of broadcast program data can be output to the outside via the HDMI terminal 2 in a secure state.

The south bridge 104 controls the devices on an LPC (Low Pin Count) bus, and the devices on a PCI (Peripheral Component Interconnect) bus. In addition, the south bridge 104 includes an IDE (Integrated Drive Electronics) controller for controlling the hard disk drive (HDD) 111 and DVD drive 112. The south bridge 104 also includes a function of executing communication with the sound controller 106.

The sound controller 106 is a sound source device, and outputs audio data, which is to be reproduced, to the speakers 18A, 18B or to the HDMI control circuit 3.

The card controller 113 controls card devices such as a PC card and an SD (Secure Digital) card. The wireless LAN controller 114 is a wireless communication device which executes wireless communication of, e.g. IEEE 802.11 standard. The IEEE 1394 controller 115 executes communication with an external device via an IEEE 1394 serial bus.

The embedded controller/keyboard controller IC (EC/KBC) 116 is a 1-chip microcomputer in which an embedded controller for power management and a keyboard controller for controlling the keyboard (KB) 13 and touch pad 16 are integrated. The embedded controller/keyboard controller IC (EC/KBC) 116 has a function of powering on/off the computer 10 in response to the user's operation of the power button 14. Further, the embedded controller/keyboard controller IC (EC/KBC) 116 has a function of executing communication with the remote-control unit interface 20.

The digital TV tuner 117 is a receiving device which receives digital broadcast programs such as ground-wave digital TV broadcast programs, and is connected to the antenna terminal 19. The digital TV tuner 117 includes a tuner circuit 201, an OFDM (Orthogonal Frequency Division Multiplexing) demodulator 202, and a copyright protection LSI 203.

In the ground-wave digital TV broadcast, MPEG2 is used as a compression-encoding scheme for broadcast program data (video, audio). In addition, SD (Standard Definition) with a standard resolution and HD (High Definition) with a high resolution can be used as video formats.

The tuner circuit 201 and OFDM demodulator 202 function as a tuner unit for receiving broadcast program data. The tuner circuit 201 receives a TV broadcast signal of a specified channel, which is selected from TV broadcast signals which are input from the antenna terminal 19. The OFDM (Orthogonal Frequency Division Multiplexing) demodulator 202 demodulates the TV broadcast signal that is received by the tuner circuit 201, and extracts a transport stream (TS) from the TV broadcast signal. The transport stream is a stream in which a plurality of compression-encoded broadcast program data are multiplexed. The transport stream includes encrypted broadcast program data (video, audio).

The copyright protection LSI 203 executes a process of decrypting the encrypted broadcast program data, and a process of re-encrypting the decrypted broadcast program data and outputting the re-encrypted broadcast program data to the system unit.

The decryption of the encrypted broadcast program data is executed by using, for example, a B-CAS card 204 which is mounted in the computer main body 11. The B-CAS card 204 is an IC card which stores information (key, authentication information, contract information, etc.) for decrypting encrypted broadcast program data. The copyright protection LSI 203 decrypts encrypted broadcast program data by using the information that is stored in the B-CAS card 204. The copyright protection LSI 203 includes a local encryption key, and re-encrypts broadcast program data on the basis of the encryption key. The encrypted broadcast program data is sent to the system unit via the PCI bus.

The CPU 101 of the system unit executes reproduction software, thereby executing a reproduction process for reproducing encrypted broadcast program data, which is sent from the digital TV tuner 117. In the reproduction process, the CPU 101 first decrypts the encrypted broadcast program data on the basis of the encryption key stored, for example, in the digital TV tuner 117. Thereafter, the CPU 101 separates the decrypted broadcast program data into video data and audio data, and decodes the video data and audio data, respectively. The CPU 101 sends the decoded video data to the GPU 105, and sends the decoded audio data to the sound controller 106.

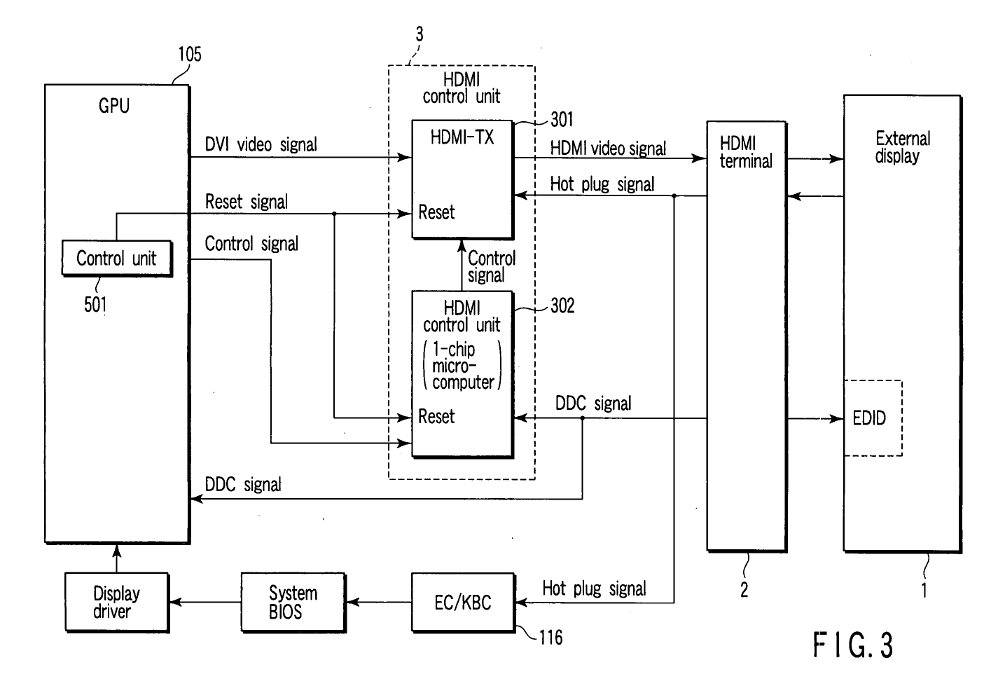

Next, referring to FIG. 3, the structure of the GPU 105 and its peripheral circuits is described.

In the digital interface of HDMI standard, a digital video signal interface, a Hot Plug interface and a DDC (Display Data Channel) interface are defined between a transmission device which transmits a digital video signal and a receiving device which receives the digital video signal.

The digital video signal interface is an interface for sending a digital video signal of HDMI standard (HDMI video signal) from the transmission device to the receiving device. The digital audio signal is sent from the transmission device to the receiving device via the digital video signal interface, for example, during a blanking period of the digital video signal.

A Hot Plug signal, which indicates whether the external display device is connected to the HDMI terminal 2, is defined in the Hot Plug interface. When the external display device is connected to the HDMI terminal 2 over a cable, the Hot Plug signal is rendered active. When the external display device is disconnected, the Hot Plug signal is rendered inactive.

The DDC (Display Data Channel) interface is an interface which enables the transmission device to read identification information of the receiving device, which is called EDID (Extended Display Identification Data). A bidirectional DDC signal line is included in the DDC interface.

The GPU 105 receives video data which is sent from the reproduction software, and generates a digital video signal, e.g. DVI (Digital Visual Interface) video signal, from the received video data. The GPU 105 sends the generated DVI video signal to the HDMI control circuit 3. In addition, the GPU 105 sends a control signal for controlling the HDMI control circuit 3 to the HDMI control circuit 3. Furthermore, the GPU 105 has a function of reading the EDID from the receiving device via the DDC signal line.

The HDMI control circuit 3 comprises, for example, an HDMI transmitter (HDMI-TX) 301 and an HDMI control unit 302.

The HDMI transmitter (HDMI-TX) 301 is an LSI which outputs the digital video signal, which is generated by the GPU 105, to the outside via the HDMI terminal 2. Specifically, the HDMI transmitter (HDMI-TX) 301 converts the DVI video signal from the GPU 105 to an HDMI video signal, and outputs the HDMI video signal to the outside via the HDMI terminal 2.

In addition, the HDMI transmitter (HDMI-TX) 301 can detect, on the basis of a Hot Plug signal from the HDMI terminal 2, whether the external display device 1 is connected to the HDMI terminal 2. The Hot Plug signal from the HDMI terminal 2 is also supplied to the EC/KBC 116.

The HDMI control unit 302 is a 1-chip microcomputer which controls the HDMI transmitter (HDMI-TX) 301. The HDMI control unit 302 has a content protection function such as HDCP. Specifically, the HDMI control unit 302 authenticates the external display device 1 by using the DDC signal. In this authentication process, the HDMI control unit 302 determines whether the external display device 1 is a lawful device which has a content protection function for protecting the digital video signal from the transmission device, that is, whether the external device 1 is an HDCP-compliant device. Only when the external display device 1 is determined to be a lawful device, the HDMI control unit 302 permit video data, which requires content protection, to be output as the HDMI video signal. The authentication process is periodically repeated, for example, at regular intervals. Thereby, the HDMI video signal is prevented from being sent to an unlawful external device.

The HDMI transmitter (HDMI-TX) 301 also has a function of encrypting the digital video signal from the GPU 105 under the control of the HDMI control unit 302. The HDMI transmitter (HDMI-TX) 301 encrypts the digital video signal from the GPU 105, converts the encrypted digital video signal to a format of the HDMI video signal, and outputs the converted signal to the external display device 1. If the external display device 1 is a lawful device, it can correctly decrypt the encrypted digital video signal that is sent from the HDMI transmitter (HDMI-TX) 301.

In a power-on sequence of an ordinary personal computer, when the personal computer is powered on, almost all the devices are reset. Then, after a predetermined time period, the reset of almost all the devices is released. Thereafter, the operating system is booted up.

Thus, if the above-described power-on sequence is applied to the HDMI control circuit 3, the HDMI control circuit 3 would be set in the active state before the operating system is booted up. Consequently, regardless of whether the subsequently booted-up operating system is an operating system that has a content protection function such as HDCP, the system environment of the computer 10 always becomes an environment in which the HDMI control circuit 3 is usable. In this case, the HDMI control circuit 3 can freely be accessed from any software. Thus, if the HDMI control circuit 3 is unlawfully operated by software, the digital video signal such as broadcast program data, which requires protection, may possibly be unlawfully copied via the HDMI terminal 2.

Besides, in the environment in which the operating system with no content protection function is running, reproduction software which runs on the operating system can freely send video data such as broadcast program data, which requires protection, to the GPU 105.

In this case, the video data is sent from the reproduction software to the GPU 105 in the entirely non-protected state. For example, the video data may be hacked by unlawful software on the input side of the GPU 105 (e.g. on a path from the main memory 103 to the GPU 105).

To cope with this, in the computer 10 of this embodiment, a control unit 501 for controlling the operation of the HDMI control circuit 3 is provided. The control unit 501 is provided, for example, in the GPU 105.

The control unit 501 executes a process for setting the HDMI control circuit 3 in the operative state after a specific operating system, which has a content protection function corresponding to HDCP, that is, a content protection function for protecting video data that is sent from the software to the GPU 105 against unlawful use is booted up. The content protection function of the specific operating system is, for instance, a function of executing transmission of video data from the reproduction software to the GPU 105 in the secure state.

Responding to power-on of the computer 10, the control unit 501 sets the reset signal for resetting the HDMI control circuit 3 in the active state (Reset=Low). The reset signal is supplied to the HDMI transmitter (HDMI-TX) 301 and HDMI control unit 302. The control unit 501 keeps the reset signal in the active state until the specific operating system having the content protection function is booted up.

After the specific operating system having the content protection function is booted up, the control unit 501 first sets the reset signal in the inactive state (Reset=High), thereby setting the HDMI control circuit 3 in the operative state (reset release state).

In a case where an operating system having no content protection function is booted up, the reset signal is kept in the active state and is never set in the inactive state.

As described above, by setting the HDMI control circuit 3 in the operative state after the operating system with the content protection function is booted up, the software is prohibited from using the HDMI control circuit 3 in the environment in which the operation system having no content protection function is running. Therefore, the possibility that unlawful copy of a digital video signal, etc. is carried out can be lowered.

In addition, in the environment in which the operation system having the content protection function is running, both the path between the reproduction software and GPU 105 and the path between the GPU 105 and the external display device 1 can be kept in the secure state. Therefore, high-image-quality digital video data can securely be sent to the external display device 1.

For example, when the control unit 501 receives a request (e.g. request for releasing the reset of the HDMI control circuit 3) from a display driver program which runs on the operating system having the content protection function, the control unit 501 determines that the specific operating system with the content protection function is booted up, and sets the reset signal in the inactive state. Thereby, without executing a special process for determining whether the booted-up operating system is a specific operating system having the content protection function, it becomes possible to confirm that the specific operating system having the content protection function is booted up.

The control unit 501 may be provided outside the GPU 105.

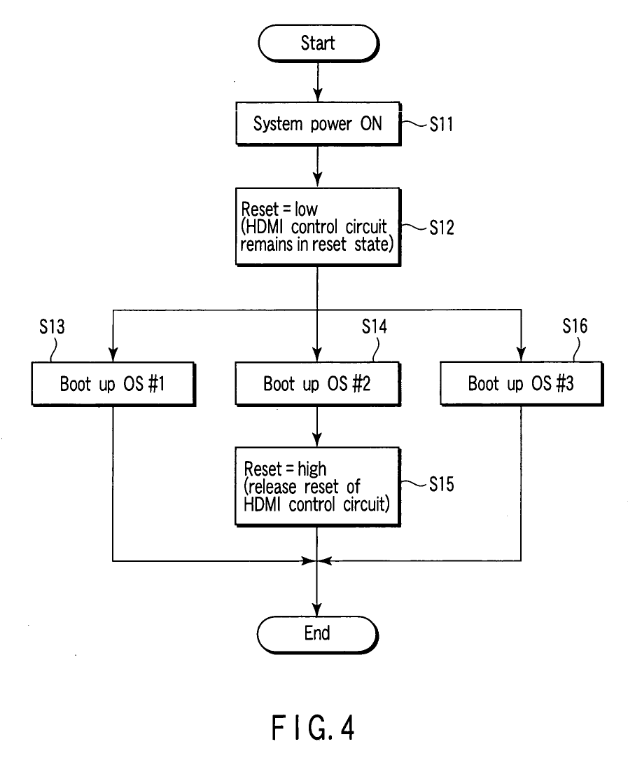

Next, referring to a flow chart of FIG. 4, the reset release sequence of the HDMI control circuit 3 is described.

If the power button 14 is operated by the user, the EC/KBC 116 supplies system power to the respective components and powers on the main body 11 (block S11). Responding to the power-on of the main body 11, the control unit 501 sets the reset signal for resetting the HDMI control circuit 3 in the active state (Reset=Low) (block S12). The components other than the HDMI control circuit 3 are also reset by a system reset signal, etc. If a predetermined time period has passed since the system reset signal was set in the active state, the system reset signal is automatically set in the inactive state. However, the reset signal for resetting the HDMI control circuit 3 is kept in the active state.

Subsequently, an operating system, which is selected by the user, for example, is booted up by the system BIOS.

In the computer 10, there are no restrictions to the use of operating systems which can be booted up. It is thus possible that various operating systems are used. Assume now that three operating systems (OS#1, OS#2, OS#3) are used. For example, OS#1 is MS-DOS® of Microsoft Corporation, OS#2 is Windows® of Microsoft Corporation, and OS#3 is Linux®. At present, only Windows® is the operating system having the content protection function corresponding to HDCP. Windows® has the content protection function corresponding to HDCP, which is called “COPP (Certified Output Protection Protocol)”.

When OS#1 or OS#3 is booted up (block S13, S16), the process of releasing the reset of the HDMI control circuit 3, i.e. the process of setting the reset signal, which is supplied to the HDMI control circuit 3, in the inactive state and setting the HDMI control circuit 3 in the operative state, is not executed and the HDMI control circuit 3 is maintained in the state (reset state) in which the operation of the HDMI control circuit 3 is halted. On the other hand, when the OS#2 is booted up (block S15), the control unit 501 sets the reset signal for resetting the HDMI control circuit 3 in the inactive state (Reset=High) after the boot-up of the OS#2 (block S15), thereby setting the HDMI control circuit 3 in the operative state (reset release state).

Basically, the timing for setting the HDMI control circuit 3 in the active state may be anytime after OS#2 is booted up. However, since the computer 10 includes the LCD 17 as the internal display device, the HDMI control circuit 3 may be set in the operative state only when the external display device 1 is selected as the display monitor of the computer 10. Whether the external display device 1 or the LCD 17 is selected as the display monitor can be determined on the basis of, for example, setup information relating to the display monitor, or the operation/non-operation of a predetermined hot key on the keyboard 13.

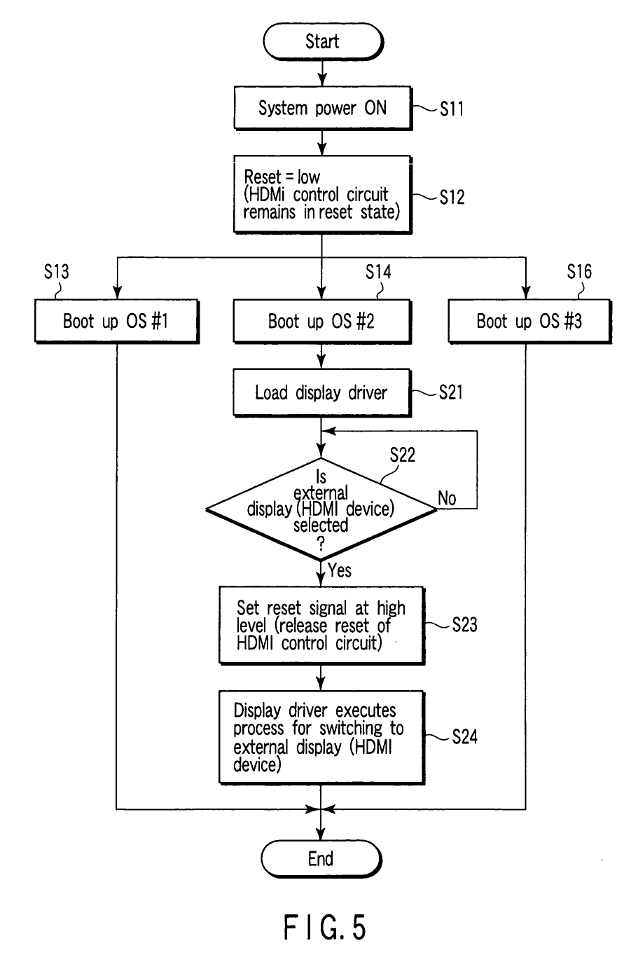

Next, referring to a flow chart of FIG. 5, a description is given of the procedure of a process of setting the HDMI control circuit 3 in the operative state under the condition that the operating system having the content protection function is booted up and the external display device 1 is selected as the display monitor.

If OS#2 is booted up (block S14), the display driver program configured to run on the OS#2 is loaded in the main memory 103 by the OS#2 (block S21). The display driver program determines whether the external display device 1 is selected as the display monitor (block S22).

If the external display device 1 is selected as the display monitor (YES in block S22), the display driver program sends a reset release request to the control unit 501. Upon receiving the reset release request, the control unit 501 sets the reset signal for resetting the HDMI control circuit 3 in the inactive state (Reset=High) (block S23), thereby setting the HDMI control circuit 3 in the operative state.

Thereafter, the display driver program controls the GPU 105 so that the digital video signal may be output to the external display device 1 via the HDMI control circuit 3 and HDMI terminal 2 (block S24).

In the meantime, the selection of the external display device 1 (HDMI monitor) is enabled only when the external display device 1 that is connected to the HDMI terminal 2 is recognized as the HDMI monitor.

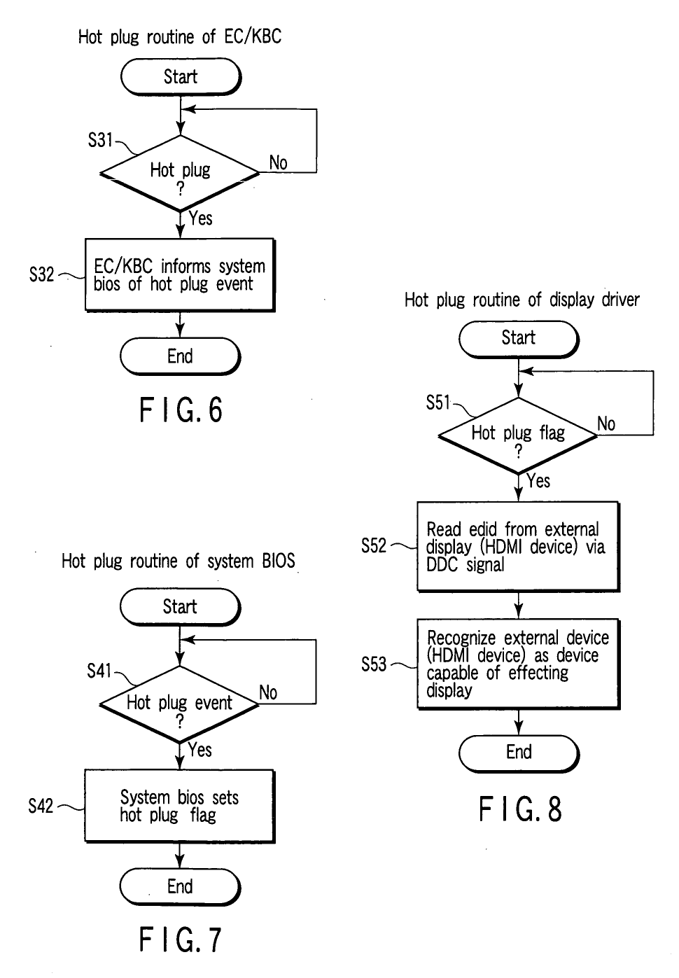

Next, referring to flow charts of FIG. 6 to FIG. 8, the procedure of the process of recognizing the HDMI monitor is described.

The EC/KBC 116 determines whether the external display device 1 is connected to the HDMI terminal 2, on the basis of the Hot Plug signal (block S31). If the external display device 1 is connected to the HDMI terminal 2 (YES in block S31), the EC/KBC 116 sends an interrupt signal to the CPU 101, thereby informing the system BIOS of the occurrence of a Hot Plug event (block S32). The same process is executed in the case where the computer 10 is powered on in the state in which the external display device 1 is connected to the HDMI terminal 2.

Upon receiving the Hot Plug event (YES in block S41 in FIG. 7), the system BIOS sets a Hot Plug flag indicative of the occurrence of the Hot Plug event, for example, in the main memory 103 or in a specific register (block S42).

If the Hot Plug flag is set (YES in block S51 in FIG. 8), the display driver program reads EDID information from the external display device 1 (block S52). On the basis of the EDID information, the display driver program determines whether the external display device 1 is the HDMI monitor. If the external display device 1 is the HDMI monitor, the display driver program recognizes the external display device 1 as a lawful device which can display protected video data (block S53).

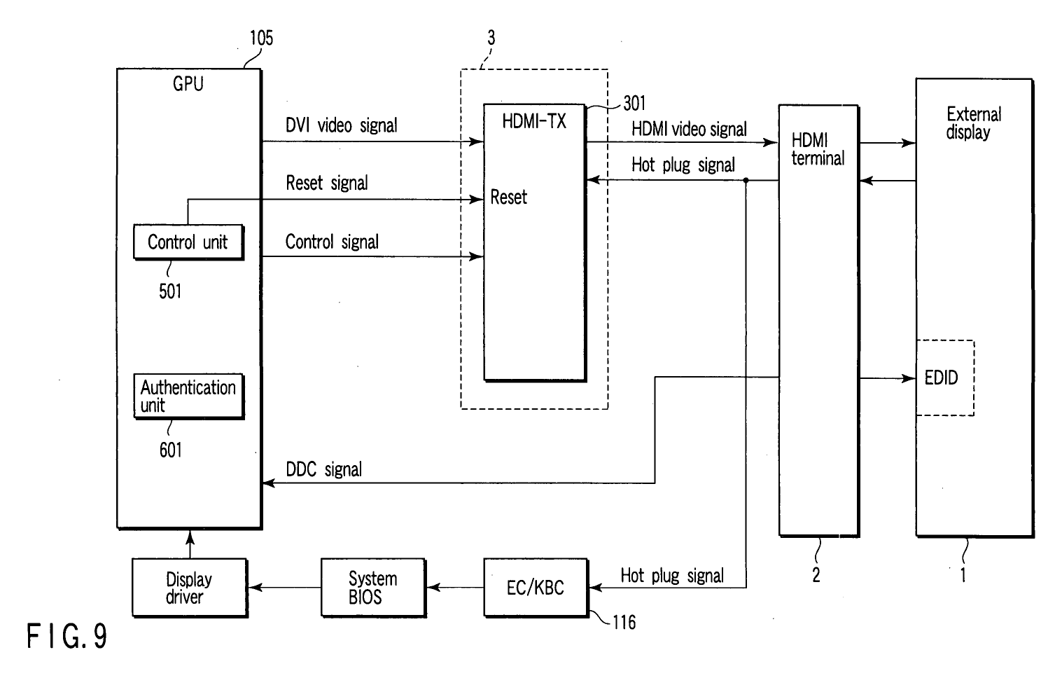

Next, referring to FIG. 9, another example of the structure of the HDMI control circuit 3 is described.

In FIG. 9, the function of the HDMI control unit 302 is provided in the GPU 105, and the HDMI control circuit 3 comprises only the HDMI transmitter (HDMI-TX) 301. The control of the HDMI transmitter (HDMI-TX) 301 is executed by the GPU 105.

An authentication unit 601 in the GPU 105 authenticates the external display device 1 by using the DDC signal. In the authentication process, the authentication unit 601 determines whether the external display device 1 is a lawful device which has a content protection function for protecting the digital video signal from the transmission device, that is, whether the external device 1 is an HDCP-compliant device. Only when the external display device 1 is determined to be a lawful device, the authentication unit 601 permit the HDMI transmitter (HDMI-TX) 301 to output the HDMI video signal.

As has been described above, in the present embodiment, the HDMI control circuit 301 is set in the operative state only in the secure environment in which the operating system having the content protection function is running. In other environments, the HDMI control circuit 301 is set in the inoperative state. Therefore, a sufficient copyright protection function is realized, and high-image-quality video data can be output to the outside.

In the present embodiment, the HDMI control circuit 301 is set in the inoperative/operative state by controlling the reset signal. However, not only by controlling the reset signal, but also by controlling, for example, the supply of the clock signal to the HDMI control circuit 301 or the supply of operation power to the HDMI control circuit 301, the HDMI control circuit 301 can be set in the inoperative/operative state.

The control of the HDMI control circuit 301 in the present embodiment can prevent not only the unlawful copy of broadcast program data but also the unlawful copy of DVD video data, etc.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
an external display connection terminal;
a display controller which receives video data from software and generates a digital video signal from the received video data;
an interface control circuit which outputs the digital video signal, which is generated by the display controller, to an outside via the external display connection terminal; and
a control unit which sets the interface control circuit in an operative state after an operating system, which has a content protection function for protecting the video data against unlawful use, is booted up.

2. The information processing apparatus according to claim 1, wherein the control unit is configured to set a reset signal for resetting the interface control circuit in an active state in response to power-on of the information processing apparatus, and to set the reset signal in an inactive state after the operating system is booted up.

3. The information processing apparatus according to claim 1, wherein the control unit is configured to set the interface control circuit in the operative state in response to a request from a display driver program which runs on the operating system.

4. The information processing apparatus according to claim 1, wherein the control unit is configured to set the interface control circuit in the operative state when the operating system is booted up and an external display device, which is connected to the external display connection terminal, is selected as a display monitor of the information processing apparatus.

5. The information processing apparatus according to claim 1, wherein the interface control circuit is configured to execute an authentication process for determining whether an external display device, which is connected to the external display connection terminal, is a lawful device, and to output the digital video signal to the external display device via the external display connection terminal when the external display device is determined to be the lawful device.

6. The information processing apparatus according to claim 1, wherein the content protection function includes a function of executing transmission of the video data from the software to the display controller in a secure state.

7. An information processing apparatus comprising:
a main body;
an external display connection terminal which is provided on the main body;
a display controller which is provided in the main body, receives video data from software and generates a digital video signal from the received video data;
means for executing an authentication process for determining whether an external display device, which is connected to the external display connection terminal, is a lawful device;
an interface control circuit which is provided in the main body, and outputs the digital video signal, which is generated by the display controller, to the external display device via the external display connection terminal when the external display device is determined to be the lawful device; and
control means for setting a reset signal for resetting the interface control circuit in an active state in response to power-on of the main body, and setting the reset signal in an inactive state after an operating system, which has a content protection function for executing transmission of the video data from the software to the display controller in a secure state, is booted up.

8. The information processing apparatus according to claim 7, wherein the control means sets the reset signal in the inactive state in response to a request from a display driver program which runs on the operating system.

9. The information processing apparatus according to claim 7, wherein the control means sets the reset signal in the inactive state when the operating system is booted up and an external display device, which is connected to the external display connection terminal, is selected as a display monitor of the information processing apparatus.

10. An operation control method for controlling an operation of an information processing apparatus including an external display connection terminal, a display controller which receives video data from software and generates a digital video signal from the received video data, and an interface control circuit which outputs the digital video signal, which is generated by the display controller, to an outside via the external display connection terminal, the method comprising:
setting the interface control circuit in an inoperative state in response to power-on of the information processing apparatus; and
setting the interface control circuit in an operative state after an operating system, which has a content protection function for protecting the video data against unlawful use, is booted up.

11. The operation control method according to claim 10, wherein said setting the interface control circuit in an inoperative state includes setting a reset signal for resetting the interface control circuit in an active state in response to power-on of the information processing apparatus, and
said setting the interface control circuit in an operative state includes setting the reset signal in an inactive state after the operating system is booted up.

12. The operation control method according to claim 10, wherein said setting the interface control circuit in an operative state includes setting the interface control circuit in the operative state in response to a request from a display driver program which runs on the operating system.

13. The operation control method according to claim 10, wherein said setting the interface control circuit in an operative state includes setting the interface control circuit in the operative state when the operating system is booted up and an external display device, which is connected to the external display connection terminal, is selected as a display monitor of the information processing apparatus.

14. The operation control method according to claim 10, wherein the interface control circuit is configured to execute an authentication process for determining whether an external display device, which is connected to the external display connection terminal, is a lawful device, and to output the digital video signal to the external display device via the external display connection terminal when the external display device is determined to be the lawful device.
